(19) United States
(12) Patent Application Publication
(10) Pub. No.: US 2006/0092895 A1
(43) Pub. Date: May 4, 2006

(54) Method for restricting push-to service

(75) Inventors: Young-Ae Kim, Gyeonggi-Do (KR); Young-Hwan Park, Seoul (KR); Kang-Suk Huh, Gyeonggi-do (KR); Hee-Joung Lee, Bucheon (KR); Sung-Mu Son, Gyeonggi-do (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/254,180

(22) Filed: Oct. 20, 2005

(30) Foreign Application Priority Data
Oct. 23, 2004 (KR) 10-2004-85139
Jan. 20, 2005 (KR) 10-2005-5566
Jan. 25, 2005 (KR) 10-2005-6871

(51) Int. Cl. H04Q 7/24

(52) U.S. Cl. 370/338; 370/352

(57) ABSTRACT

A method for restricting a push-to (PT) service restricts a PT service with reference to network information. A PT client inviting to a PT session restricts an invited PT client by setting a network dependent outgoing session barring flag as ‘ON’. A PT client invited to the PT session restricts the inviting PT client by setting a network dependent incoming session barring flag as ‘ON’. The inviting PT client or the invited PT client can be selectively restricted by using information on operation conditions under which the flags are operated.

### BACKGROUND OF THE INVENTION

1. Field of the Invention

The present invention relates to a “push-to” (PT) service and, more particularly, to a method for restricting a PT service capable of restricting a PT service with reference to network information when a client inviting a PT session and a client invited to the PT session belong to a different network.

2. Description of the Related Art

A PT service, which is intended to provide rapid communications for service providers and consumers of mobile network, is a communication service in which one client transmits media data (talk burst) to one or more other clients with which a session has been established. A PT service can be a push to talk (PTT) service for transmission of voice (audio) data, a push to view (PTV) service for transmission of moving picture (video) data, or a push to data (PTD) service for transmission of data. The PT service allows communication with a single recipient (1-to-1) or between groups of recipients as in a group chat session (1-to-many), and uses a session initiation protocol (SIP) to establish a session.

A related art PT service includes selecting by a specific client one or more clients to invite them to a PT session, connecting a session between the specific client inviting to the PT session and the invited client(s), and transmitting/receiving data between the session-established clients.

The client, who is invited to the PT session, can set an incoming session barring flag as ‘ON’ to limit an invitation to every PT session or can limit a PT session invitation according to clients or groups where a client belongs. However, the PT session limitation method has a problem that a client, who invites to the PT session or is invited to the PT session, discriminately limits an invitation without considering information of a network where the client is located.

The related art PT service does not definitely define a session establishing method for a case where a client who invites to a PT session or a client who is invited to the PT session exist in a different network. Because each network uses a different fee charging policy, if the client who invites to the PT session and the invited client exist in a different network and there is no function for limiting a process for inviting to the PT session and a process for being invited, a problem related to fee charging can arise.

For example, if the client invited to the PT session belongs to a different country network, the client can be charged at a much higher rate for a service compared with a client who belongs to the same country network. In this case, however, since the PT session is set without considering as to whether the client belongs to the same country network or belongs to a different country network, a user may be charged with an unexpected service fee.

### BRIEF DESCRIPTION OF THE INVENTION

Therefore, one object of the present invention is to provide a method for restricting a PT service capable of limiting an inviting function based on network information when a client invites a client who belongs to a different network to a PT session.

Another object of the present invention is to provide a method for restricting a PT service capable of restricting an invited function based on network information when a client is invited to a PT session of a client who belongs to a different network.

To achieve at least the above objects in whole or in parts, there is provided a method for restricting a PT service including: setting by a first PT client network information for restricting session establishment; determining whether a network of a second PT client who desires to establish a session with the first PT client satisfies the set network information; and stopping session establishment by the first PT client with the second PT client if the network information of the second PT client satisfies the network information.

To achieve at least these advantages in whole or in parts, there is further provided a method for restricting a PT service in a PT service system in which a first PT client invites one or more PT clients and establishes a session, including: setting network information for restricting a first PT client to invite a PT client existing in a specific network; and restricting invitation of a PT client satisfying the set network information among invited PT clients.

To achieve at least these advantages in whole or in parts, there is further provided a method for restricting a PT service in which a first PT client of a first network sets network information so that it can restrict an invitation of a second PT client who has moved from the first network to a second network, including: receiving by a first PT server an invite signal transmitted by the first PT client through a first SIP/IP core; adding by the first PT server the network information in the invite signal and transmitting it to the first SIP/IP core; and checking by the first SIP/IP core current network of the second PT client and informing the first PT client that session establishment has been stopped if the second PT client belong to the second network.

To achieve at least these advantages in whole or in parts, there is further provided a method for restricting a PT service in which a first PT client of a first network sets network information in order to restrict invitation of a second PT client who has moved from the first network to a second network, including: receiving by a first PT server an invite signal transmitted by the first PT client through a first SIP/IP core; checking by the first PT server current network of the second PT client; and informing by the first PT server the first PT client that session establishment has been stopped if the second PT client belongs to the second network.

To achieve at least these advantages in whole or in parts, there is further provided a method for restricting a PT service in which a first PT client of a first PT network sets network information to restrict connection with one or more PT clients of a second network who has/have been moved into a third network, including: transmitting by the first PT client an invite signal to a first PT server; adding by the first PT server the network information in the invite signal and transmitting it to a second SIP/IP core of the second network; and informing by the second SIP/IP core the first PT client that session establishment with a PT client which had been moved to the third network has been stopped.

To achieve at least these advantages in whole or in parts, there is further provided a method for restricting a PT service in which a first PT client of a first PT network sets network information to restrict connection with one or more PT clients of a second network who has/have been moved into a third network, including: receiving by a first PT server an invite signal from the first PT client; checking by the first PT server a current network of the second PT client from the second PT network; and informing by the first PT server the first PT client that session establishment with a PT client who had been moved to the third network has been stopped.

To achieve at least these advantages in whole or in parts, there is further provided a method for restricting a PT service in which a first PT client of a first network sets network information to restrict an invitation of a second PT client who does not belong to the first network, including: receiving by a first PT server an invite signal transmitted by the first PT client; and checking by the first PT server a URI (Uniform Resource Identifier) of the second PT client and informing the first PT client that session establishment has been stopped.

To achieve at least these advantages in whole or in parts, there is further provided a method for restricting a PT service, including: transmitting by a first PT client belonging to a first network an invite signal to a second PT client belonging to the first network; establishing a session between the first and second PT clients; if the second PT client roams to a second network, comparing, by the first network, the current network of the second PT client and pre-set network information; and if the network of the second PT client satisfies the pre-set network information, transmitting by the first network a release signal to the first and second PT clients.

To achieve at least these advantages in whole or in parts, there is further provided a method for restricting a PT service, including: storing by a first PT client network information for restricting invitation to a specific network in a first PT server; and restricting by the first PT server an invitation when an inviting network satisfies the set network information.

To achieve at least these advantages in whole or in parts, there is further provided a method for restricting a PT service in which a first PT client of a first network sets network information for restricting an invitation to a second network, including: receiving by a first PT server an invite signal from the second network; comparing by the first PT server the network information and information of the second network, and informing the second network that session establishment has been stopped.

To achieve at least these advantages in whole or in parts, there is further provided a method for restricting a PT service of a PT system in which a network-dependent outgoing session barring flag and operation condition information is set for a PT server to restrict an invitation with respect to specific PT clients, wherein when an outgoing session barring override flag transmitted through a terminal by a user is set, a session is established regardless of the set outgoing session barring flag and operation condition information.

To achieve at least these advantages in whole or in parts, there is further provided a method for restricting a PT service, including: setting a PT session establishment condition in an application server; receiving by the application server a request for PT session establishment and comparing the session establishment condition with a current session establishment state; and selectively performing a session connection according to the comparison result.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram showing the construction of an exemplary PT system for explaining a method for restricting a PT service in accordance with the present invention;

FIG. 2 is a signal flow chart illustrating an exemplary process for transmitting by a PT client ‘A’ a publish signal to a PT server ‘A’;

FIG. 3 is a signal flow chart illustrating an exemplary process for transmitting by a PT client ‘B’ a publish signal to a PT server ‘B’;

FIG. 4 is a signal flow chart illustrating an exemplary process of transmitting a subscriber signal and a notify signal between PT clients or between PT servers;

FIG. 5 is a signal flow chart illustrating an exemplary method for restricting a PT service in accordance with a first embodiment of the present invention;

FIG. 6a is a signal flow chart illustrating an exemplary method for restricting a PT service in accordance with a second embodiment of the present invention;

FIG. 6b is a signal flow chart illustrating an exemplary method for restricting a PT service in accordance with a third embodiment of the present invention;

FIG. 7 is a signal flow chart illustrating an exemplary method for restricting a PT service in accordance with a fourth embodiment of the present invention;

FIG. 8a is a signal flow chart illustrating an exemplary method for restricting a PT service in accordance with a fifth embodiment of the present invention;

FIG. 8b is a signal flow chart illustrating an exemplary method for restricting a PT service in accordance with a sixth embodiment of the present invention;

FIG. 9 is a signal flow chart illustrating an exemplary method for restricting a PT service in accordance with a seventh embodiment of the present invention;

FIG. 10 is a signal flow chart illustrating an exemplary method for restricting a PT service in accordance with an eighth embodiment of the present invention;

FIG. 11 is a signal flow chart illustrating an exemplary method for restricting a PT service in accordance with a ninth embodiment of the present invention;

FIG. 12 is a signal flow chart illustrating an exemplary method for restricting a PT service in accordance with a tenth embodiment of the present invention;

FIG. 13a is a signal flow chart illustrating an exemplary method for restricting a PT service in accordance with an eleventh embodiment of the present invention;

FIG. 13b is a signal flow chart illustrating an exemplary method for restricting a PT service in accordance with a twelfth embodiment of the present invention;

FIG. 14 is a view illustrating network information, which is set for restricting a session by PT clients, expressed in an XML document; and

FIGS. 15a and 15b are views illustrating an outgoing session barring override flag, which is transmitted through a terminal of a user, expressed in an SDP (Session Description Protocol) format and in an XML document.

### DETAILED DESCRIPTION OF THE INVENTION

A method for restricting a PT service in accordance with preferred embodiments of the present invention will now be described with reference to the accompanying drawings.

In the present invention, a PT client who invites to a PT session can restrict an invited PT client by setting a network dependent outgoing session barring flag as ‘ON’.

In addition, a PT client invited to a PT session can restrict an inviting PT client by setting a network dependent incoming session barring flag as ‘ON’.

Also, in the present invention, a PT client can selectively restrict an inviting PT client or an invited PT client by using the network dependent outgoing session barring flag, the network dependent incoming session barring flag and information of a condition in which the flags are operated. In this case, the condition information refers to information for designating a specific network or information on whether a specific network is a foreign network or a long distance network, or the like. The condition information can be URI information of a client who wants to restrict inviting or being invited.

FIG. 1 is a block diagram showing the construction of a PT system for explaining a method for restricting a PT service in accordance with the present invention. With reference to FIG. 1, a network 100 of a PT client ‘A’ and a network 200 of a PT client ‘B’ are different networks and can have the same structure.

The networks 100 and 200 include PT clients 110 and 210 providing a user interface, PT servers 120 and 220 for processing a PT signal and media data, presence servers 130 and 230 for checking state information of the PT clients 110 and 210 and transferring it to a different network, and SIP/IP cores 140 and 240 for routing an SIP (Session Initiation Protocol) message, respectively. The SIP/IP cores 140 and 240 correspond to an IMS (IP Multimedia Subsystem) in the 3GPP and an MMD in the 3GPP2.

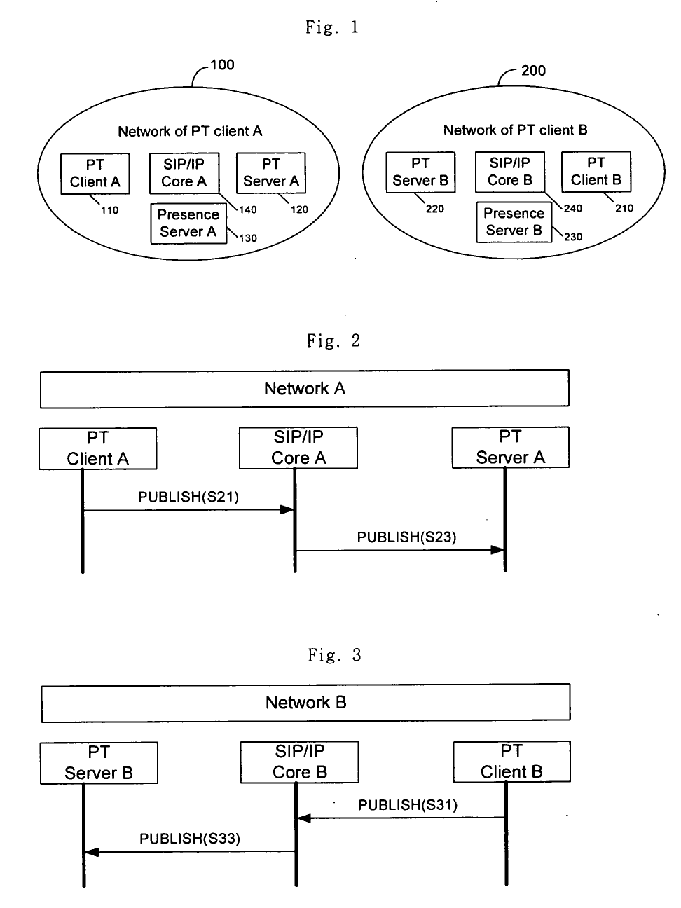

FIGS. 2 to 4 are signal flow charts illustrating a basically required function for implementing the method for restricting a PT service in accordance with the present invention. The function will now be described.

FIG. 2 is a signal flow chart illustrating a method for restricting invitation of clients belonging to a different network by the PT client ‘A’ from its serving network. For the sake of explanation, the PT client ‘A’ and the PT client ‘B’ belonging to a different network ‘B’ from that of the PT client ‘A’ will be described.

The PT client ‘A’ transfers a value of the network dependent outgoing session barring flag and information on a condition under which the corresponding flag is operated to the SIP/IP core ‘A’ by using a publish signal of an SIP (step S21), and the SIP/IP core ‘A’ transfers the received publish signal to the PT server ‘A’.

The PT server ‘A’ stores the value of the network dependent outgoing session barring flag and the information on condition under which the corresponding flag is operated. In this case, instead of the publish signal of the SIP, a PUP calculation of an XML (extensible Markup Language) configuration access protocol can be also used.

FIG. 3 is a signal flow chart for the PT client ‘B’ (of a serving network) that restricts an invitation from a client belonging to a network other than the serving network. For the sake of explanation, the PT client ‘A’ belonging to the network ‘A’ that is different than the network for the PT client ‘B’ will be described.

The PT client ‘B’ transfers the value of the network dependent incoming session barring flag and the information on the condition under which the corresponding flag is operated to the SIP/IP core ‘B’ by using the publish signal of the SIP (step S31), and the SIP/IP core transfers the received publish signal to the PT server ‘B’ (step S33).

The PT server ‘B’ stores the value of the network dependent incoming session barring flag and the information on condition under which the corresponding flag is operated. In this case, instead of the publish signal of the SIP, a PUT calculation of an XML (extensible Markup Language) configuration access protocol can be also used.

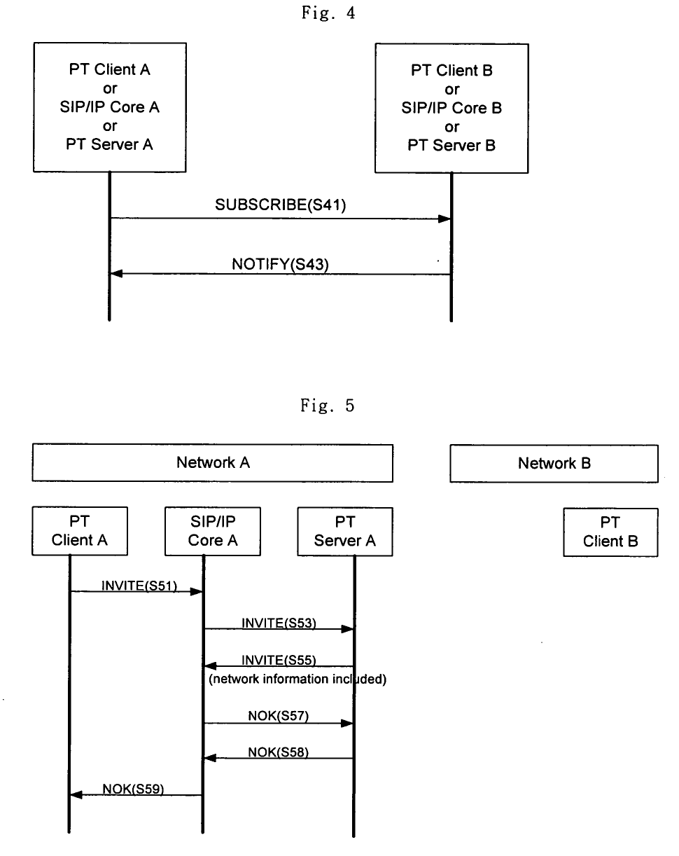

FIG. 4 is a flow chart illustrating a process of inquiring and responding of desired information between PT clients, between SIP/IP cores or between PT servers. A PT client or an SIP/IP core or a PT server requests information desired to be obtained by using a subscriber signal (step S41), and another PT client or SIP/IP core or PT server provides the requested information through a notify signal (step S43).

Namely, the PT client ‘A’ that invites to a PT session or the invited PT client ‘B’ can pre-store the network dependent outgoing session barring flag value and operation condition information or the network dependent incoming session barring flag value and operation condition information in the PT server ‘A’ or the PT server ‘B’ of the corresponding network through the publish signal, and the stored information can be transmitted through the subscriber signal and the notify signal.

FIGS. 5 to 10 are signal flow charts illustrating the method for restricting a PT service in accordance with embodiments of the present invention. The method for restricting a PT service will now be described in detail with reference to the drawings.

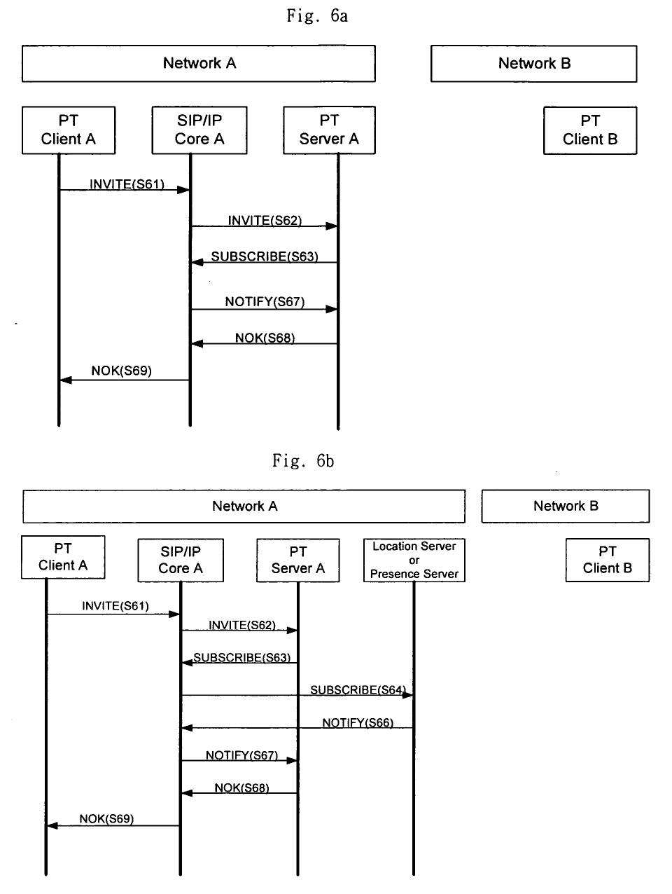

FIGS. 5, 6a and 6b are signal flow charts illustrating a method for restricting a PT service in case where an inviting PT client ‘A’ and an invited PT client ‘B’ are clients of the same service provider of the same country, and the PT client ‘B’ moves to a network of a service provider in a different country. In this case, it is assumed that the PT client ‘A’ has previously set a network dependent outgoing session barring flag value and operation condition information in the PT server ‘A’ in order to restrict invitation of a PT client of a specific network ‘B’ (a network of a different country).

FIG. 5 shows a case where the SIP/IP core restricts an invitation. When the PT client ‘A’ invites the PT client ‘B’ by using an invite signal (step S51), the SIP/IP core routes the invite signal to the PT server ‘A’ (step S53).

If the network dependent outgoing session barring flag value which has been previously set by the PT client ‘A’ is ‘ON’, the PT server ‘A’ adds the flag value and the information on the condition under which the corresponding flag is operated to the invite signal and transmits it to the SIP/IP core ‘A’ (step S55). Namely, a ‘network dependent outgoing session barring flag=0 and operation condition=network of a different country’ is added to the invite signal.

When the PT client ‘B’ (namely, a subscriber of the network ‘A’) initially moves to the network ‘B’ (a network of a different country), it reports information on the current network to the SIP/IP core ‘A’ by using a register signal, so the SIP/IP core ‘A’ knows that the PT client ‘B’ has moved to the current network ‘B’. In this case, the SIP/IP core ‘A’ must have a database (or the like) for mapping country information or area information through the information reported by the PT client ‘B’.

Upon receiving the invite signal, the SIP/IP core ‘A’ checks that the network dependent outgoing session barring flag value is ‘ON’ and the operation condition information that a PT client of the network (network ‘B’) of a different country is not desired to be invited, and then, it stops the session invitation with respect to the PT client ‘B’.

The SIP/IP core ‘A’ informs the PT server ‘A’ that session establishment with respect to the PT client ‘B’ has been stopped by using a NOK signal (step S57), the PT server ‘A’ transmits the NOK signal to the SIP/IP core ‘A’ (step S58), and the SIP/IP core transmits the NOK signal to the PT client ‘A’ (step S59).

FIG. 6a shows a case where the PT server ‘A’ restricts an invitation, in which the PT server ‘A’ receives information on a current network of an inviting PT client from the SIP/IP core.

When the PT client ‘A’ invites the PT client ‘B’ by using an invite signal (step S61), the SIP/IP core ‘A’ routes the invite signal to the PT server ‘A’ (step S62).

If the network dependent outgoing session barring flag value previously set by the PT client ‘A’ is ‘ON’, the PT server ‘A’ transmits a subscriber signal to the SIP/IP core ‘A’ in order to request information on a current network of the PT client ‘B’ (step S63) and the SIP/IP core ‘A’ informs the PT server ‘A’ which network the PT client ‘B’ belongs to through a notify signal (step S67).

The PT server ‘A’ determines whether to invite the PT client ‘B’ by comparing the operation condition information previously set by the PT client with the information of the current network of the PT client ‘B’ received from the SIP/IP core ‘A’.

For example, when a ‘network dependent outgoing session barring flag=ON and operation condition=a network of a different country’ has been previously set and the PT client ‘B’ checked through the SIP/IP core ‘A’ belongs to a network (network B) of a different country, the PT server ‘A’ stops the session invitation with respect to the PT client.

The PT server ‘A’ informs the SIP/IP core ‘A’ through a NOK signal that session establishment with respect to the PT client ‘B’ has been stopped (step S68) and the SIP/IP core ‘A’ transmits the NOK signal to the PT client ‘A’ (step S69).

The network information of the PT client ‘B’ can be checked through a process of requesting by the PT server ‘A’ by using the subscriber-notify signal or through a process in which the SIP/IP core ‘A’ informs the PT server ‘A’ about the network information of the PT client ‘B’ by using a publish signal periodically or whenever the network information is changed.

FIG. 6b is a different embodiment of restricting an invitation by the PT server ‘A, in which the PT server ‘A’ receives information on a current network of an inviting PT client from a different application server. In this case, the application server can be a location server or a presence server.

When the PT client ‘A’ invites the PT client ‘B’ by using an invite signal (step S61), the SIP/IP core ‘A’ routes the invite signal to the PT server ‘A’ (step S62).

If the network dependent outgoing session barring flag value previously set by the PT client is ‘ON’, the PT server ‘A’ transmits a subscribe signal to the SIP/IP core ‘A’ in order to request the current network information of the PT client ‘B’ from the application server (position server or presence server) (step S63), and the SIP/IP core ‘A’ routes the subscribe signal to the application server (location server or the presence server) (step S64).

The application server transmits a notify signal including the information on the network where the PT client ‘B’ currently belongs to the PT server ‘A’ through the SIP/IP core ‘A’ (step S66 and S67). At this time, the SIP/IP core ‘A’ routes the notify signal which has been received from the application server to the PT server ‘A’.

The PT server ‘A’ determines whether to invite the PT client ‘B’ by comparing the operation condition information previously set by the PT client ‘A’ and the current network information of the PT client ‘B’ received from the application server. At this time, the PT server ‘A’ must have a database (or the like) for mapping the network information received from the application server to country information or area information.

For example, when a ‘network dependent outgoing session barring flag=ON and operation condition=a network of a different country’ has been previously set and the PT client ‘B’ checked through the SIP/IP core ‘A’ belongs to a network (network B) of a different country, the PT server ‘A’ stops the session invitation with respect to the PT client.

The PT server ‘A’ informs the SIP/IP core ‘A’ through a NOK signal that session establishment with respect to the PT client ‘B’ has been stopped (step S68) and the SIP/IP core ‘A’ transmits the NOK signal to the PT client ‘A’ (step S69).

In a different embodiment of the present invention, if an inviting PT client ‘A’ and an invited PT client ‘B’ are clients of the same service provider of the same country and a service area of the service provider is relatively broad (large), inviting of PT clients belonging to a long distance service can be restricted. Namely, when a PT server is discriminated according to its network service coverage, connection of a session among PT servers can be restricted. In this case, a long distance network can be discriminated by a network ID.

Here, an outgoing session barring flag value and operation condition information set by the PT client ‘A’ for restricting an invitation with respect to a PT client existing in a specific network ‘B’ (long distance service) can be ‘network dependent outgoing session barring flag=ON and operation condition=long distance network’.

Namely, the case of restricting an invitation of a PT client belonging to a long distance area is the same as the operation of the cases as described with reference to FIGS. 5, 6a and 6b except that the flag value and the operation condition information is set as ‘network dependent outgoing session barring flag=ON and operation condition=long distance network’.

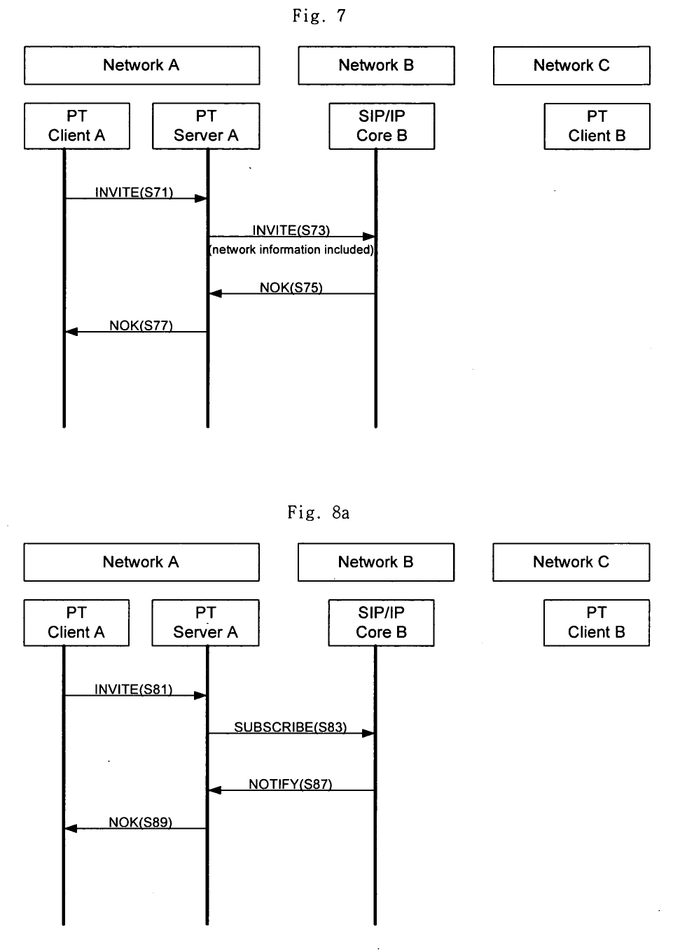

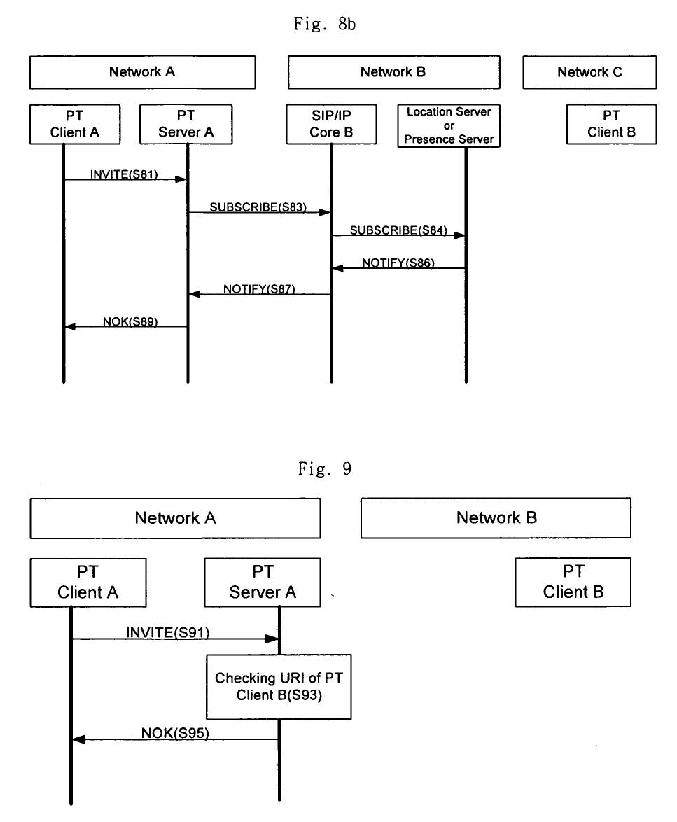

FIGS. 7, 8a and 8b are signal flow charts illustrating a method for restricting a PT server when an inviting PT client ‘A’ and an invited PT client ‘B’ are clients of a different service provider of the same country and the PT client ‘B’ has moved to a network of a different country or to a network of a long distance area. It is assumed that the PT client ‘A’ previously set a network dependent outgoing session barring flag value and operation condition information in the PT server ‘A’ in order to restrict invitation of a PT client existing in a specific network ‘C’ (a network of a different country or a long distance network).

FIG. 7 shows a case where the SIP/IP core restricts an invitation according to operation condition information.

When the PT client ‘A’ invites the PT client ‘B’ by using an invite signal (step S71), the PT server ‘A’ routes the invite signal to the SIP/IP core ‘B’ of the home network ‘B’ of the PT client.

If the network dependent outgoing session barring flag value previously set by the PT client ‘A’ is ‘ON’, the PT server ‘A’ adds the flag value and information on a condition under which the flag is operated to the invite signal and transmits it to the SIP/IP core ‘B’ (step S73). Namely, the invite signal can additionally include ‘network dependent outgoing session barring flag=ON and operation condition=foreign network or long distance network’.

When the PT client ‘B’ (namely, a subscriber of the network ‘B’) initially moves to the network ‘C’ (network of a different country or a long distance service network), it reports information on the current network to the SIP/IP core ‘B’ by using a register signal, so the SIP/IP core ‘B’ knows that the PT client ‘B’ has moved to the current network ‘C’. In this case, the SIP/IP core ‘B’ must have a database (or the like) for mapping country information or area information through the information reported by the PT client ‘B’.

Upon receiving the invite signal, the SIP/IP core ‘B’ checks that the network dependent outgoing session barring flag value is ‘ON’ and the operation condition information that a PT client of the network (network ‘C’) of a different country is not desired to be invited, and then, it stops the session invitation with respect to the PT client ‘B’.

The SIP/IP core ‘A’ informs the PT server ‘A’ that session establishment with respect to the PT client ‘B’ has been stopped by using a NOK signal (step S75), and the PT server ‘A’ transmits the NOK signal to the PT client ‘A’ (step S77).

FIG. 8a is a signal flow chart illustrating a case where the PT server ‘A’ restricts an invitation, in which the PT server ‘A’ receives information on a current network of a PT client to be invited from the SIP/IP core.

When the PT client ‘A’ invites the PT client ‘B’ by using an invite signal (step S81), the PT server ‘A’ transmits a subscribe signal to the SIP/IP core ‘B’ of the home network ‘B’ to request current network information of the PT client ‘B’ (step S83).

The SIP/IP core ‘B’ informs the PT server ‘A’ about which network the PT client ‘B’ belongs to through a notify signal (step S87).

The PT server ‘A’ determines whether to invite the PT client by comparing the operation condition information previously set by the PT client and the current network information of the PT client ‘B’ received from the SIP/IP core ‘B’.

For example, if ‘network dependent outgoing session barring flag=ON and operation condition=a network of a different country or a long distance service’ has been previously set in the PT server ‘A’ and the current PT client ‘B’ checked through the SIP/IP core ‘B’ belongs to a different country network (network ‘C’), the PT server ‘A’ stops the session invitation with respect to the PT client ‘B’.

The PT server ‘A’ informs the PT client through a NOK signal that session establishment with respect to the PT client ‘B’ has been stopped (step S89).

The network information of the PT client ‘B’ can be checked through a process of requesting by the PT server ‘A’ by using a subscribe-notify signal, or can be checked by allowing the SIP/IP core ‘B’ to inform the PT server ‘A’ by using a publish signal periodically or whenever the network information of the PT client ‘B’ is changed.

FIG. 8b is a signal flow chart illustrating a case where the PT server ‘A’ restricts an invitation in accordance with a different embodiment of the present invention, in which the PT server ‘A’ receives information on a current network of an inviting PT client from an application server.

When the PT client ‘A’ invites the PT client ‘B’ by using an invite signal (step S81), the PT server ‘A’ transmits a subscribe signal to the SIP/IP core ‘B’ of the home network ‘B’ of the PT client (step S83), and the SIP/IP core ‘B’ routes the subscribe signal to the application server (step S84). In this case, the application server is the location server ‘B’ or the presence server ‘B’.

The application server transmits a notify signal including information on a network to which the PT client ‘B’ belongs to the SIP/IP core ‘B’ (step S86), and the SIP/IP core ‘B’ routes the notify signal to the PT server ‘A’ (step S87).

The PT server ‘A’ determines whether to invite the PT client ‘B’ by comparing the operation condition information previously set by the PT client ‘A’ and current network information of the PT client ‘B’ transmitted from the application server.

For example, in case where ‘network dependent outgoing session barring flag=ON and operation condition=network of a different country or a long distance service’ have been previously set in the PT server ‘A’ and the current PT client ‘B’ checked through the SIP/IP core ‘B’ belongs to a network (network ‘C’) of a different country, the PT server ‘A’ stops the session invitation with respect to the PT client ‘B’.

The PT server ‘A’ informs the PT client through a NOK signal that session establishment with respect to the PT client ‘B’ has been stopped (step S89).

The network information of the PT client ‘B’ can be checked through a process of requesting by the PT server ‘A’ by using a subscribe-notify signal, or can be checked by allowing the SIP/IP core ‘B’ to inform the PT server ‘A’ by using a publish signal periodically or whenever the network information of the PT client ‘B’ is changed.

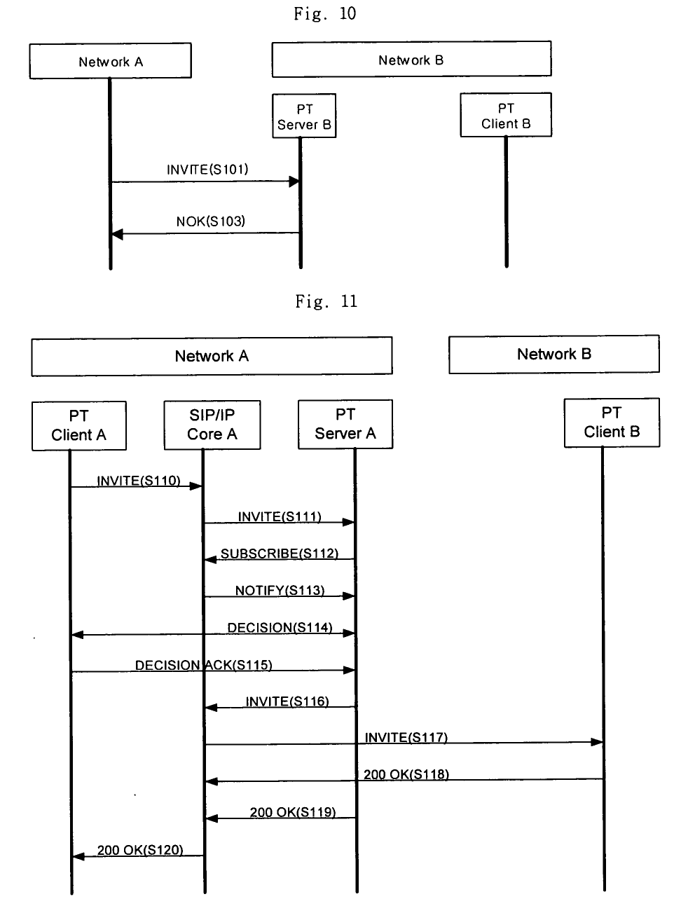

FIG. 9 is a signal flow chart illustrating a method for restricting a PT service in case where an inviting PT client ‘A’ wants to exclude a PT client ‘B’ of a service provider of a different country or a specific group. In this respect, it is assumed that the PT client ‘A’ previously sets a network dependent outgoing session barring flag value and operation condition information in the PT server ‘A’ in order to restrict an invitation with respect to the PT client of a specific network ‘B’ (service provider of a different country) or a specific group.

The PT client ‘A’ transmits an invite signal to the PT server ‘A’ in order to invite the PT client ‘B’ (step S91). At this time, the PT server ‘A’ has the stored network dependent outgoing session barring flag value and information on conditions under which a corresponding flag is operated previously set by the PT client ‘A’. The flag value and the operation condition information are ‘network dependent outgoing session barring flag=0 and the operation condition=a service provider of a different country or a specific group’.

The PT server ‘A’ checks a URI (Uniform Resource Identifier) of the invited PT client ‘B’ in order to check whether the PT client ‘B’ is a client of a service provider of a different country or a specific group (step S93). In this case, the URI can be a phone number URI (Tel URI) or an SIP URI.

When the PT server ‘A’ checks that the network dependent outgoing session barring flag value is ‘ON’ and operation condition information that a PT client of a service provider of a different country or a specific group is not to be invited, it stops session invitation with respect to the PT client ‘B’ having a URI of the service provider of a different country or a specific group. And then, the PT server ‘A’ informs the PT client ‘A’ by using a NOK signal that the session establishment with respect to the PT client ‘B’ has been stopped (step S95).

For example, when a PT client ‘A’ (a client of a domestic service provider) invites one or more PT clients, the PT server ‘A’ checks a URI of each invited PT client and sorts out a client of a service provider of a different country. If a country code of a phone number URI of the invited PT client ‘B’ is of a different country (+081-XXX-XXX-XXXX) or has an SIP URI (sip:jenny@ntt.com) of a service provider of a different country, the PT server ‘A’ does not invite the PT client ‘B’. In this case, the PT server ‘A’ must have a database (or the like) for determining whether the invited PT client is a subscriber of a service provider of a different country or a member of a group of subscribers of a different country through the URI.

FIGS. 5 to 9 shows a case where an inviting PT client restricts an invitation with respect to a PT client who satisfies a network dependent outgoing session barring flag value and information of conditions under which the corresponding flag is operated, in which it is assumed that network information such as the flag value and the operation condition information is previously set in the PT server before an invite signal is transmitted.

However, the network dependent outgoing session barring flag value and the operation condition information can be directly added in the invite signal transmitted by the PT client and transmitted. Namely, the inviting PT client adds the flag value and the operation condition information into the invite signal and transmits it, and then, the PT server checks the flag value and the operation condition information from the invite signal.

FIG. 10 is a signal flow illustrating PT service method for restricting an invitation by an inviting PT client, in which an invitation received from a network of a different country or a network of a long distance area is restricted.

First, the PT client ‘B’ previously sets a network dependent incoming session barring flag value and operation condition information in the PT server ‘B’ in order to restrict an invitation transmitted from a specific network ‘A’ (a network of a different country or a long distance area network).

When an invite signal for inviting the PT client ‘B’ is transmitted to the PT server ‘B’ (step S101), the PT server ‘B’ checks an origination of the invite signal by checking the incoming session barring flag value and the information of conditions under which the corresponding flag is operated previously set by the PT client ‘B’.

For example, when ‘network dependent incoming session barring flag=0 and operation condition=network of a different country, a long distance network or a subscriber number of a different country’ has been set, the PT server ‘B’ checks whether the invite signal has been received from a network of a different country or a long distance area network, or whether the invite signal is an invite signal which has been transmitted by a subscriber of a different country.

The PT server ‘B’ checks operation condition information that the PT client ‘B’ does not want to be invited by a network of a different county or a long distance area network, or by a subscriber of a different country, and stops the session invitation with respect to the PT client ‘B’.

The PT server ‘B’ informs the network ‘A’ by a NOK signal that the session establishment has been stopped (step S103).

In the embodiments with reference to FIGS. 5 to 10, if the invited PT client satisfies the network dependent outgoing session barring flag value and the information on conditions under which the corresponding flag is operated, the PT server immediately restricts an invitation with respect to the PT client. And if the PT client satisfies the network dependent incoming session barring flag value and information on conditions under which the corresponding flag is operated, the PT server immediately restricts an invitation from the PT client.

However, in the embodiments of FIGS. 5 to 10, a PT server confirmation process can be additionally performed to allow re-checking by the PT client (PT user) who has set the conditions to determine restriction of an invitation with respect to the PT client who satisfies the network dependent outgoing session barring flag value and information on the conditions under which the corresponding flag is operated and the network dependent incoming session barring flag value and the information of conditions under which the corresponding flag is operated.

For example, when the PT client previously sets both operation conditions of the outgoing session barring flag and user checking conditions, the PT server can allow the checking conditions of a user to be invited to have a higher priority level than the operation conditions of the outgoing session barring flag.

FIG. 11 is a signal flow chart illustrating the additional performing of checking by the PT server restriction of an invitation.

When the PT client ‘A’ invites the PT client ‘B’ by using an invite signal (step S110), the SIP/IP core ‘A’ routes the invite signal to the PT server ‘A’ (step S1).

The PT server ‘A’ transmits a subscribe signal to the SIP/IP core ‘A’ in order to request information on a current network of the PT client ‘B’ (step S112), and the SIP/IP core ‘A’ informs the PT server ‘A’, through a notify signal, about which network the PT client ‘B’ belongs to (step S113). In this case, it is assumed that an outgoing session barring flag value set in the PT server ‘A’ is ‘ON’, operation condition information of the flag is ‘network of a different country’ and the PT client exists in a network of a different country.

The PT server inquires whether to continue or stop the session establishment with the PT client ‘B’ by transmitting a decision signal including network information of the PT client ‘B’ to the PT client ‘A’ regardless of the set flag value (step S114). In this case, the decision signal can include information on an address of an overseas/domestic network, information on an address of a long distance/short distance network, and fee charging-related information.

The PT server ‘A’ waits for transmission of an invite signal for inviting the PT client ‘B’ until a response with respect to the decision signal is transmitted. At this time, a timer (or similar function) for limiting the waiting time can be set, so that when the waiting time elapses, the PT server ‘A’ can restrict an invitation according to previously set operation condition information.

Upon receiving the decision signal, the PT client ‘A’ determines whether to continue the session establishment and transmits a decision value through a decision ACK signal to the PT server (step S115).

Here, it is assumed that the PT client ‘A’ transmits a decision ACK signal including a value for commanding continuously proceeding with session establishment with respect to the PT client ‘B’.

The PT server ‘A’ receives the decision ACK signal and transmits the invite signal to the PT client ‘B’ through the SIP/IP core ‘A’ (steps S116, S117), and the PT client ‘B’ transmits a response (200 OK) with respect to the invite signal to the PT server ‘A’ through the SIP/IP core ‘A’ (step S118 and S119). As the PT server ‘A’ transmits the response (200 OK) to the PT client ‘A’, a session is established between the PT client ‘A’ and the PT client ‘B’.

When the process in which the PT server allows the PT client to check session establishment is added, the decision of the PT client has a higher priority level than restriction of an invitation according to the flag value and condition information previously set in the PT server.

For example, if ‘network dependent outgoing session barring flag=ON and operation condition=network of a different country’ has been previously set and the PT client ‘B’ checked through the SIP/IP core ‘A’ belongs to a network (network ‘B’) of a different country, when the PT client ‘A’ determines to establish a session, the PT server ‘A’ establishes a session with the PT client ‘B’ regardless of the pre-set conditions.

In addition, an invitation from a specific PT client can be restricted by using the decision signal and the decision ACK signal.

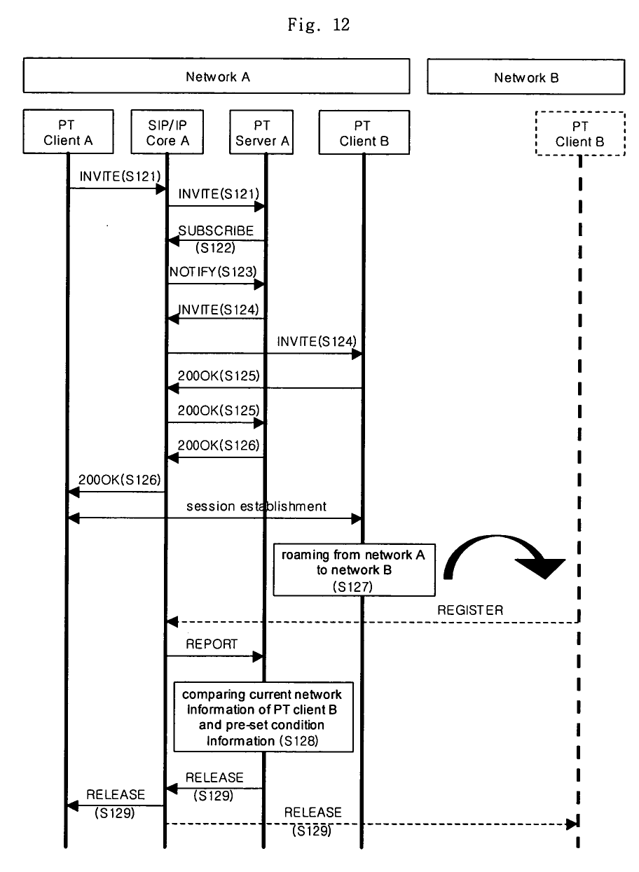

FIG. 12 is a signal flow chart illustrating a method for restricting a PT service in case where after the PT client ‘A’ invites the PT client ‘B’ existing in the same network and establishes a session, the PT client ‘B’ roams to a different network. In this case, it is assumed that the PT client ‘A’ had previously set a network dependent outgoing session barring flag value and operation condition information in the PT server ‘A’ in order to restrict an invitation with respect to a PT client existing in a specific network ‘B’ (network of a different country or a long distance area network).

First, a case where the PT client ‘A’ and the PT client ‘B’ belong to the same country network or the same service provider and the PT sever restricts a PT service will be considered.

When the PT client ‘A’ invites the PT client ‘B’ by using an invite signal, the SIP/IP core ‘A’ routes the invite signal to the PT server ‘A’ (step S121).

If the network dependent outgoing session barring flag value previously set by the PT client ‘A’ is ‘ON’, the PT server ‘A’ transmits a subscribe signal to the SIP/IP core ‘A’ in order to request current network information of the PT client ‘B’ (step S122), and the SIP/IP core ‘A’ informs the PT server ‘A’ through a notify signal which network the PT client ‘B’ belongs to (step S123).

The PT server ‘A’ checks that the PT client ‘A’ and the PT client ‘B’ exist in the same network and transmits the invite signal to the PT client ‘B’ through the SIP/IP core ‘A’ (step S124). Namely, since the PT client ‘B’ does not satisfy the condition information, restriction of a PT service does not occur.

Upon receiving the invite signal, the PT client ‘B’ transmits a response (200 OK) signal to the PT server ‘A’ through the SIP/IP core ‘A’ (step S125), and the PT server ‘A’ transmits the response (200 OK) signal to the PT client ‘A’ through the SIP/IP core ‘A’ (step S126), whereby a session is established between the PT client ‘A’ and the PT client ‘B’.

When the PT client ‘B’ roams to the network ‘B’ while the session is established between the PT client ‘A’ and the PT client ‘B’ (step S127), the PT server ‘A’ compares the network information of the current PT client ‘B’ with the network dependent outgoing session barring flag value and information on conditions under which the corresponding flag is operated (step S128).

When the PT client ‘B’, namely, a subscriber of the network ‘A’ initially moves to the network ‘B’ (network of a different country), it transmits a register signal to the SIP/IP core ‘A’ to register the currently positioned network, so the SIP/IP core ‘A’ knows that the PT client ‘B’ has roamed to the current network ‘B’. And the SIP/IP core ‘A’ informs the PT server ‘A’ through a report signal that the PT client ‘B’ has roamed.

The PT server checks that the network dependent outgoing session barring flag value is ‘ON’ and the condition information that a client of a different network (network ‘B’) is not desired to be invited, and transmits a session release signal to the PT client ‘A’ and the PT client ‘B’, so that the session between the PT client ‘A’ and the PT client ‘B’ is released (step S129).

As mentioned above, when the PT client roams to a different network while the session is established, the PT service can be restricted by the SIP/IP core as well as by the PT server.

When the invited PT client ‘B’ moves to a different area (a different network or a PT server region) while the session is being performed, the PT server or the SIP/IP core can release the session according to condition information of the inviting PT client ‘A’.

Meanwhile, when the invited PT client ‘B’ moves to a different area (different network, a PT server region, etc.) while the session is being performed, the PT server or the SIP/IP core can release the session according to preference information of the invited PT client ‘B’.

When the inviting PT client ‘A’ is moved to a different area (different network, different PT server region, etc.) while performing a session with the invited PT client ‘B’, the corresponding session can be terminated according to preference information of the PT client ‘A’.

In addition, when the inviting PT client ‘a’ moves to a different area (different network, different PT server region, etc.) while performing a session with the invited PT client ‘B’, a corresponding session can be terminated according to preference information of the PT client ‘B’.

In the above-described embodiments, the inviting PT client can restrict an invitation with respect to the PT clients who satisfy the condition by using the network dependent outgoing session barring flag and operation condition information of the flag.

However, the PT client can set an outgoing session barring override flag and can transmit it to the PT server to override the flag and the operation condition information previously set in the PT server. The outgoing session barring override flag can be added in a header or a body of the invite signal transmitted by the PT client and transmitted to the PT server.

When the outgoing session barring override flag set by a user is transmitted to the PT server, the PT server operates as follows.

If the outgoing session barring override flag is ‘true’, the PT server is operated regardless of the outgoing session barring flag and the operation condition information stored in the PT server. Thus, the PT server unconditionally transmits the invite signal to targets of invitation (namely, invitees). In this case, if there is no process for inquiring of the invitation targets (invitees) about whether to establish a session, a session can be immediately set (established) between the inviter and the invitees. For example, the PT server does not inform the inviter about whether there is an invitee who has moved to a network of a different country or a long distance network and fee charging information when there is such an invitee who has moved to a network of a different country or a long distance network and override the outgoing session barring flag stored in the PT server to thereby connect the PT session. Meanwhile, if there is a process for inquiring of an invitee about whether to establish a session, the session is established according to a decision of the invitee.

If the outgoing session barring override flag is ‘false’, the PT server is operated according to the outgoing session barring flag and the operation condition information stored in the PT server. In this case, if there is no process of inquiring of an invitee about whether to establish a session, the PT server is operated according to the outgoing session barring flag and the operation condition information set in the PT server, while if there is a process of inquiring of an invitee about whether to establish a session, a session is established according to a decision of the invitee.

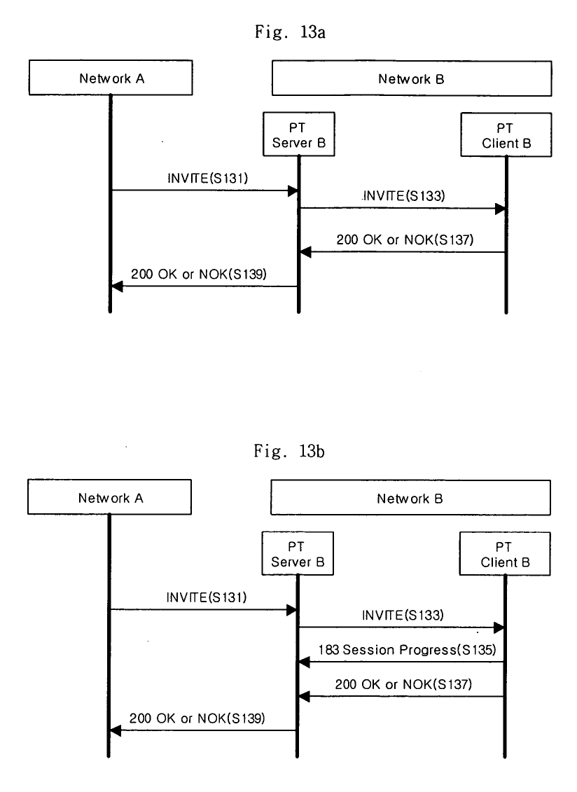

FIGS. 13a and 13b illustrate an invitation process in case where an outgoing session barring override flag included in an invite signal is ‘True’.

FIG. 13a is a signal flow chart illustrating adding of a step of restricting an invitation according to a decision of the PT client to the process of FIG. 10. In this case, it is assumed that the PT client ‘B’ had previously set a network dependent incoming session barring flag value and operation condition information in the PT server ‘B’ in order to restrict an invitation transmitted from a specific network ‘A’ (network of a different country or a long distance area network).

The network ‘A’ adds an outgoing session barring override flag in an invite signal for inviting the PT client ‘B’ and transmits it (step S131). Herein, the outgoing session barring override flag value is ‘True’. Upon receiving the invite signal, the PT server ‘B’ transmits the invite signal to the PT client ‘B’ regardless of the pre-set flag value and the operation condition information according to the outgoing session barring override flag (step S133). In this case, the invite signal includes information based on which a network of an inviter can be determined and fee charging-related information.

Upon receiving the invite signal, the PT client ‘B’ determines whether to join the session and transmits a response signal with respect to the invite signal to the PT server ‘B’ (step S137). In this case, a response signal in case of joining the session is ‘200 OK’ and a response signal in case of not joining the session is ‘NOK’.

The PT server ‘B’ transmits the response signal which has been received from the PT client ‘B’ to the network ‘A’ (step S139).

FIG. 13b is a signal flow chart illustrating an additional step of restricting an invitation according to a decision of the PT client to the process of FIG. 10, in which the PT client ‘B’ transmits a request signal for requesting waiting for transmission of a response signal with respect to the invite signal to the PT server ‘B’.

The network ‘A’ adds the outgoing session barring override flag having a ‘true’ value in the invite signal inviting the PT client ‘B’ and transmits it (step S131). Upon receiving the invited signal, the PT server ‘B’ transmits the invite signal to the PT client regardless of the pre-set flag value and the operation condition information according to the outgoing session barring override flag (step S133). IN this case, the invite signal can include information (e.g., overseas/home network address information or long distance/short distance network address information, etc.) based on which a network of an inviter can be determined and fee charging-related information.

Upon receiving the invite signal, the PT client ‘B’ transmits a request signal requesting waiting for transmission of a response signal with respect to the invite signal until joining of the session invitation is determined (step S135). As the request signal, an SIP response message such as a ‘183 session progress’, ‘202 accepted’ or ‘180 ringing’, etc. can be used.

The PT client B determines whether to join the session, and transmits a response signal with respect to the invite signal to the PT server ‘B’ (step S137). In this case, a response signal in case of joining the session is ‘200 OK’ and a response signal in case of not joining the session is ‘NOK’.

The PT server B transmits a response signal which has been received from the PT client ‘B’ to the network ‘A’ (step S139).

As shown in FIGS. 13a and 13b, when the outgoing session barring override flag is included in the invite signal and if the flag value is ‘True’, the invite signal is transmitted to an invitee (the PT client ‘B’) regardless of the flag value and the condition information stored in the PT server, and the session is established or stopped according to a decision of the invitee.

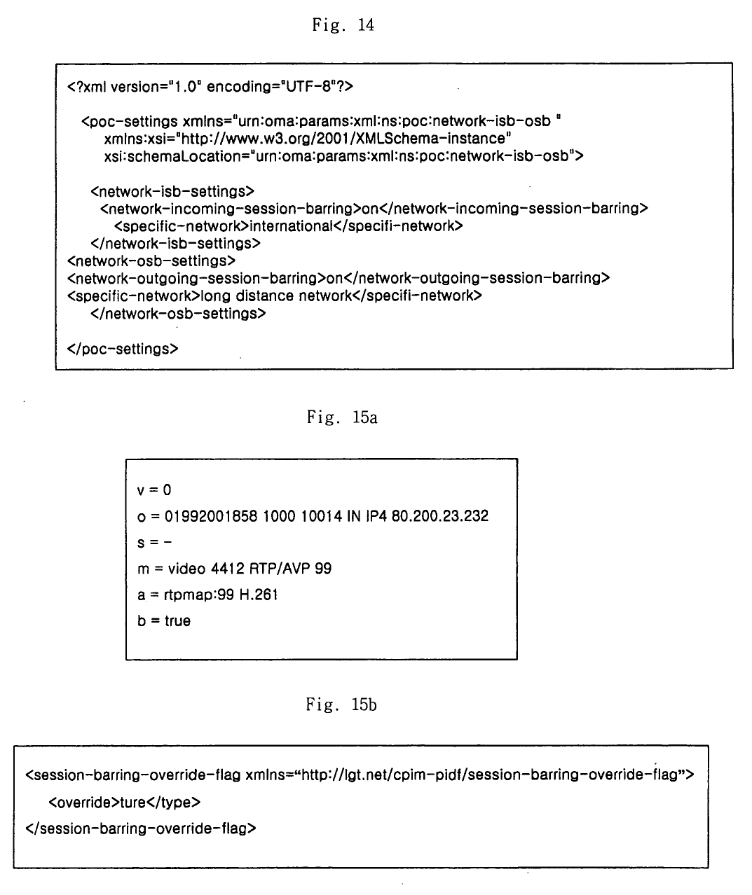

FIG. 14 is a view illustrating network information, which is set for restricting a session by PT clients, expressed in an XML document format. In case of an incoming session, an international invitation is restricted, and in case of an outgoing session, a long distance area network is restricted. In this case, the network includes a network dependent incoming session barring flag, operation condition information of the corresponding flag, a network dependent outgoing session barring flag, and operation condition information of the corresponding flag.

FIGS. 15a and 15b are views illustrating an outgoing session barring override flag, which is transmitted through a terminal of a user, expressed in an SDP (Session Description Protocol) format and in an XML document format.

In FIG. 15a, ‘b=true’ means that the outgoing session barring override flag value is ‘true’, and ‘b’ is the first letter of ‘barring’.

In the present invention, when the PT client performs a PT service in its original home network or when the PT client performs a PT service in a home network set after having roamed to a different network area (or different PT server region), the network dependent outgoing session barring/network dependent incoming session barring (OSB/ISB) can be performed.

The session barring conditions described in the present invention are not limited to location information such as roaming or long distance, and session barring can be performed according to various conditions by the application server according to user settings.

Namely, the application server can perform session barring by using various state information such as state information of a PT session, state information of an inviting PT subscriber himself, state information of an invited subscriber, a domain of a service provider of the invited PT subscriber, and the like.

As so far described, the method for restricting a PT service in accordance with the present invention has the following advantages.

That is, network information for restricting a client for inviting to a PT session or an invited client from inviting or being invited is set, and a client who satisfies the network information is automatically restricted for inviting or being invited, so user convenience can be enhanced.

In addition, a client inviting to a PT session or an invited client can restrict an inviting network or an invited network by using network information, so a problem related to fee charging caused when a session is established between clients who exist in a different network can be solved.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A method for restricting a push-to (PT) service comprising:
setting network information for restricting session establishment;
determining whether a network of inviting PT client or invited PT client satisfies the network information; and
stopping session establishment between the PT clients if the network of at least one of the inviting PT client and the invited PT client satisfies the network information.

2. The method of claim 1, wherein the network information is set by the invited PT client or the inviting PT client.

3. The method of claim 1, wherein the network information comprises at least one or more of:
a network dependent outgoing session barring flag indicating whether to restrict an invited network;
information on operation conditions under which the network dependent outgoing session barring flag is operated;
a network dependent incoming session barring flag indicating whether to restrict an inviting network; and
information on operation conditions under which the network dependent incoming session barring flag is operated.

4. The method of claim 3, wherein the operation condition information includes information indicating a network of a different country or a long distance area network.

5. The method of claim 3, wherein the operation condition information includes Uniform Resource Identifier information of a client to be restricted for invitation.

6. The method of claim 3, wherein if the network dependent outgoing session barring flag value is ‘ON’, the invited network is restricted.

7. The method of claim 3, wherein if the network dependent incoming session barring flag value is ‘ON’, the inviting network is restricted.

8. A method for restricting a push-to (PT) service in a PT service system in which a first PT client invites one or more PT clients and establishes a session, the method comprising:
setting network information for restricting a first PT client to invite a PT client existing in a specific network; and
restricting invitation of a PT client satisfying the set network information among invited PT clients.

9. The method of claim 8, wherein the network information comprises:
a network dependent outgoing session barring flag indicating whether to restrict an invited network; and
information on operation conditions under which the network dependent outgoing session barring flag is operated.

10. The method of claim 9, wherein the operation condition information includes information indicating a network of a different country or a long distance area network.

11. The method of claim 9, wherein the operation condition information includes Uniform Resource Identifier information of a client desired to be restricted for invitation.

12. The method of claim 9, wherein when the network dependent outgoing session barring flag value is ‘ON’, the invited network is restricted.

13. The method of claim 8, wherein the network information is previously stored in a first PT server or added in the invite signal and transmitted to the first PT server, before the first PT client transmits the invite signal to one or more PT clients.

14. The method of claim 8, wherein the step of restricting an invitation comprises one of:
restricting an invitation by an SIP/IP server of a network which manages the PT client satisfying the set network information; and
restricting an invitation by a first PT server which manages the first PT client.

15. The method of claim 14, wherein the step of restricting an invitation by the SIP/IP server comprises:
adding, by the first PT server, the set network information in the invite signal and transmitting such; and
restricting, by the SIP/IP which has received the invite signal, an invitation with respect to a PT client satisfying the set network information.

16. The method of claim 14, wherein the step of restricting an invitation by the first PT server comprises one of:
checking a current network of invited PT clients from an SIP/IP server of a network which manages the PT clients satisfying the set network information, and restricting an invitation with respect to the PT clients satisfying the network information; and
checking a current network of invited PT clients from an application server of a network which manages the PT clients satisfying the set network information, and restricting an invitation with respect to the PT clients satisfying the network information.

17. The method of claim 16, wherein the application server is a location server or a presence server.

18. The method of claim 14, wherein the step of restricting an invitation by the first PT server further comprises:
transmitting, by the first PT server, information on invited PT clients and a signal for checking whether to join a session to the first PT client; and
receiving a response signal with respect to the signal from the first PT client and restricting an invitation with respect to the PT client according to the response signal.

19. The method of claim 18, the step further comprises:
establishing, by the PT server, a session with the PT clients regardless of the set network information, if the response signal instructs joining of a session; and
restricting, by the PT server, an invitation from the PT clients according to the set network information, if the response signal instructs not joining of the session.

20. The method of claim 18, wherein the step further comprises:
restricting, by the PT server, an invitation from the PT clients according to the set network information if the response signal is not received within a certain time.

21. The method of claim 8, wherein when the first PT client sets an outgoing session barring override flag and transmits it, a session is established regardless of the set network information.

22. A method for restricting a push-to (PT) service in which network information for restricting an invitation with respect to a second PT client which has moved from a first network to a second network is set, the method comprising:
receiving, by a first PT server, an invite signal transmitted by the first PT client through a first SIP/IP core;
adding, by the first PT server, the network information into the invite signal and transmitting such to the first SIP/IP core; and
checking, by the first SIP/IP core, a current network of the second PT client and informing the first PT client that session establishment has been stopped if the second PT client belongs to the second network.

23. The method of claim 22, wherein the network information comprises:
a network dependent outgoing session barring flag indicating whether to restrict an invited network; and
information on operation conditions under which the network dependent outgoing session barring flag is operated.

24. The method of claim 22, wherein if the network dependent outgoing session barring flag value is ‘ON’, the invited network is restricted.

25. The method of claim 22, wherein the network information is previously stored in the first PT server or added in the invite signal and transmitted to the first PT server, before the first PT client transmits the invite signal.

26. The method of claim 22, wherein the invite signal further comprises an outgoing session barring override flag for overriding network information set in the first PT server.

27. A method for restricting a push-to (PT) service in which network information for restricting an invitation with respect to a second PT client which has moved from a first network to a second network is set, the method comprising:
receiving, by a first PT server, an invite signal transmitted by the first PT client through a first SIP/IP core;
checking, by the first PT server, current network of the second PT client; and
informing, by the first PT server, the first PT client that session establishment has been stopped if the second PT client belongs to the second network.

28. The method of claim 27, wherein the network information comprises:
a network dependent outgoing session barring flag indicating whether to restrict an invited network; and
information on operation conditions under which the network dependent outgoing session barring flag is operated.

29. The method of claim 28, wherein if the network dependent outgoing session barring flag value is ‘ON’, the invited network is restricted.

30. The method of claim 27, wherein the network information is previously stored in the first PT server or added in the invite signal and transmitted to the first PT server, before the first PT client transmits the invite signal.

31. The method of claim 27, wherein the step of checking the current network of the second PT client comprises one of:
checking, by the first PT server, the current network of the second PT client from the first SIP/IP core; and
checking, by the first PT server, the current network of the second PT client from an application server.

32. The method of claim 31, wherein the application server is a location server or a presence server.

33. The method of claim 27, further comprising:
checking, by the first PT server, the current network of the second PT client and transmitting information on the second PT clients and a signal for checking whether to join a session to the first PT client; and
receiving a response signal with respect to the signal from the first PT client and restricting an invitation with respect to the second PT client according to the response signal.

34. The method of claim 33, the step comprises:
establishing, by the first PT server, a session with the second PT client regardless of the set network information if the response signal instructs joining of the session; and
restricting, by the first PT server, an invitation from the second PT clients according to the set network information if the response signal instructs not joining of the session.

35. The method of claim 33, further comprising:
restricting by the PT server an invitation from PT clients according to the set network in formation if the response signal is not received within a certain time.

36. The method of claim 27, wherein the invite signal includes an outgoing session barring override flag for overriding the network information set in the first PT server.

37. A method for restricting a push-to (PT) service in which network information for restricting connection with one or more PT clients of a second network which have been moved to a third network is set, the method comprising:
transmitting, by the first PT client, an invite signal to a first PT server;
adding, by the first PT server, the network information in the invite signal and transmitting it to a second SIP/IP core of the second network; and
informing, by the second SIP/IP core, the first PT client that session establishment with a PT client that moved to the third network has been stopped.

38. The method of claim 37, wherein the network information comprises:
a network dependent outgoing session barring flag indicating whether to restrict an invited network; and
information on operation conditions under which the network dependent outgoing session barring flag is operated.

39. The method of claim 38, wherein if the network dependent outgoing session barring flag value is ‘ON’, the invited network is restricted.

40. The method of claim 37, wherein the network information is previously stored in the first PT server or added in the invite signal and transmitted to the first PT server, before the first PT client transmits the invite signal.

41. The method of claim 37, wherein the invite signal includes an outgoing session barring override flag for overriding the network information set in the first PT server.

42. A method for restricting a push-to (PT) service in which network information for restricting connection with one or more PT clients of a second network which have been moved to a third network is set, the method comprising:
receiving, by a first PT server, an invite signal from the first PT client;
checking, by the first PT server, a current network of the second PT client from the second PT network; and
informing, by the first PT server, the first PT client that session establishment with a PT client that moved to the third network has been stopped.

43. The method of claim 42, wherein the network information comprises:
a network dependent outgoing session barring flag indicating whether to restrict an invited network; and
information on operation conditions under which the network dependent outgoing session barring flag is operated.

44. The method of claim 43, wherein if the network dependent outgoing session barring flag value is ‘ON’, the invited network is restricted.

45. The method of claim 42, wherein the network information is previously stored in the first PT server or added in the invite signal and transmitted to the first PT server, before the first PT client transmits the invite signal.

46. The method of claim 42, wherein the step of checking the current network of the second PT client comprises one of:
checking, by the first PT server, the current network of the second PT client from a second SIP/IP core of the second network; and
checking, by the first PT server, the current network of the second PT client from an application server of the second network.

47. The method of claim 46, wherein the application server is a location server or a presence server.

48. The method of claim 42, further comprising:
checking, by the first PT server, the current network of the second PT client and transmitting information on the second PT clients and a signal for checking whether to join a session to the first PT client; and
receiving a response signal with respect to the signal from the first PT client and restricting an invitation with respect to the second PT client according to the response signal.

49. The method of claim 48, the step comprises:
establishing, by the first PT server, a session with the second PT client regardless of the set network information if the response signal instructs joining of the session; and
restricting, by the first PT server, an invitation from the second PT clients according to the set network information if the response signal instructs not joining of the session.

50. The method of claim 48, further comprising:
restricting, by the PT server, an invitation from PT clients according to the set network in formation if the response signal is not received within a certain time.

51. The method of claim 42, wherein the invite signal includes an outgoing session barring override flag for overriding the network information set in the first PT server.

52. A method for restricting a push-to (PT) service in which network information for restricting an invitation with respect to a client which does not belong to a first network, the method comprising:
receiving, by a first PT server, an invite signal transmitted by the first PT client; and
checking, by the first PT server, a Uniform Resource Identifier (URI) of the second PT client, and informing the first PT client that session establishment has been stopped, if the second PT client does not belong to the first network.

53. The method of claim 52, wherein the first PT server includes a database for discriminating which network the URI belongs to.

54. The method of claim 52, wherein the network information comprises:
a network dependent outgoing session barring flag indicating whether to restrict an invited network; and
information on operation conditions under which the network dependent outgoing session barring flag is operated.

55. The method of claim 54, wherein if the network dependent outgoing session barring flag value is ‘ON’, the invited network is restricted.

56. The method of claim 52, wherein the network information is previously stored in the first PT server or added in the invite signal and transmitted to the first PT server, before the first PT client transmits the invite signal.

57. The method of claim 52, further comprising:
checking, by the first PT server, a URI of the second PT client and transmitting information on the second PT clients and a signal for checking whether to join a session to the first PT client; and
receiving a response signal with respect to the signal from the first PT client and restricting an invitation with respect to the second PT client according to the response signal.

58. The method of claim 57, the step comprises:
establishing, by the first PT server, a session with the second PT client regardless of the set network information if the response signal instructs joining of the session; and
restricting, by the first PT server, an invitation from the second PT clients according to the set network information if the response signal instructs not joining of the session.

59. The method of claim 57, further comprising:
restricting by the PT server an invitation from PT clients according to the set network in formation if the response signal is not received within a certain time.

60. The method of claim 52, wherein the invite signal includes an outgoing session barring override flag for overriding the network information set in the first PT server.

61. A method for restricting a push-to (PT) service, the method comprising:
transmitting, by a first PT client belonging to a first network, an invite signal to a second PT client belonging to the first network;
establishing a session between the first and second PT clients;
if the second PT client roams to a second network, comparing, by the first network, the current network of the second PT client and pre-set network information;
if the network of the second PT client satisfies the pre-set network information, transmitting by the first network, a release signal to the first and second PT clients.

62. The method of claim 61, wherein the network information comprises:
a network dependent outgoing session barring flag indicating whether to restrict an invited network; and
information on operation conditions under which the network dependent outgoing session barring flag is operated.

63. The method of claim 62, wherein if the network dependent is outgoing session barring flag value is ‘ON’, the invited network is restricted.

64. The method of claim 61, wherein the network information is previously stored in the first PT server or added in the invite signal and transmitted to the first PT server, before the first PT client transmits the invite signal.

65. The method of claim 61, wherein the step of comparing the network information by the first network comprises:
checking, by a first SIP/IP core of the first network, the network information from a first PT server of the first network; and
comparing the current network of the second PT client with the network information.

66. The method of claim 61, wherein the step of comparing the network information by the first network comprises:
receiving, by the first PT server, information on the current network of the second PT client from the first SIP/IP core; and
comparing the current network of the second PT client with the pre-set network information.

67. A method for restricting a push-to (PT) service, the method comprising:
storing, by a first PT client, network information for restricting invitation to a specific network in a first PT server; and
restricting, by the first PT server, an invitation when an inviting network satisfies the set network information.

68. The method of claim 67, wherein the network information comprises:
a network dependent incoming session barring flag indicating whether to restrict a network inviting the first PT client; and
information on operation conditions under which the network dependent incoming session barring flag is operated.

69. The method of claim 68, wherein if the network dependent incoming session barring flag value is ‘ON’, the inviting network is restricted.

70. The method of claim 67, wherein the step of restricting an invitation by the first PT server further comprises:
providing, by the first PT server, information on the inviting network and a signal for checking whether to join a session to the first PT client; and
receiving a response signal with respect to the signal from the first PT client and restricting the invitation according to the response signal.

71. The method of claim 70, further comprising:
establishing, by the PT server, a session regardless of the set network information, if the response signal instructs joining of the session; and
restricting, by the PT server, an invitation from the network according to the set network information, if the response signal instructs not joining of the session.

72. A method for restricting a push-to (PT) service in which network information for restricting a first PT client of a first network from being invited to a second network is set, the method comprising:
receiving by a first PT server an invite signal from the second network;
comparing by the first PT server the network information and information of the second network, and informing the second network that session establishment has been stopped if the information of the second network satisfies the network information.

73. The method of claim 72, wherein the network information comprises:
a network dependent incoming session barring flag indicating whether to restrict a network inviting the first PT client; and
information on operation conditions under which the network dependent incoming session barring flag is operated.

74. The method of claim 73, wherein if the network dependent incoming session barring flag value is ‘ON’, the inviting network is restricted.

75. The method of claim 72, wherein the step of transmitting the session establishment result to the second network, comprises:
transmitting, by the first PT server, information of the second network and a signal for checking whether to join a session to the first PT client
receiving a response signal with respect to the signal from the first PT client; and
restricting by the first PT server the invitation according to the response signal.

76. The method of claim 75, further comprising:
transmitting, by the first PT client, a signal for instructing the first PT server to defer transmission of the response signal to the invite signal after receiving the signal for checking whether to join the session.

77. The method of claim 75, further comprising:
establishing, by the PT server, a session regardless of the set network information, if the response signal instructs joining of the session; and
restricting, by the PT server, an invitation from the network according to the set network information, if the response signal instructs not joining of the session.

78. A method for restricting a push-to (PT) service of a PT system in which a network-dependent outgoing session barring flag and operation condition information is set for a PT server to restrict an invitation with respect to specific PT clients, wherein,
when an outgoing session barring override flag transmitted through a terminal by a user is set, a session is established regardless of the set outgoing session barring flag and operation condition information.

79. The method of claim 78, wherein if the outgoing session barring override flag is not set, an invitation is restricted according to the set outgoing session barring flag and the operation condition information.

80. The method of claim 79, wherein the outgoing session barring override flag is included in a header or a body of an invite signal transmitted by the terminal.

81. A method for restricting a push-to (PT) service, the method comprising:
setting a PT session establishment condition in an application server;
receiving by the application server a request for PT session establishment and comparing the session establishment condition with a current session establishment state; and
selectively performing a session connection according to the comparison result.

82. The method of claim 81 wherein the application server is a PT server.

83. The method of claim 81, wherein if a current session establishment state is the same as the session establishment condition, the PT session connection process is terminated

84. The method of claim 81, wherein if the current session establishment state is different from the session establishment condition, the PT session connection is performed.
